(19) United States
(12) Patent Application Publication
(10) Pub. No.: US 2020/0031155 A1
(43) Pub. Date: Jan. 30, 2020

(54) COOKBOOK FOR PEOPLE WITH READING DISORDERS

(71) Applicant: Sarabeth Witbart, Sparta, IL (US)

(72) Inventor: Sarabeth Witbart, Sparta, IL (US)

(21) Appl. No.: 16/520,453

(22) Filed: Jul. 24, 2019

Related U.S. Application Data
(60) Provisional application No. 62/711,813, filed on Jul. 30, 2018.

(51) Int. Cl. B42D 1/00; B42D 15/00

(52) U.S. Cl. CPC B42D 1/009; G09B 19/00; B42D 15/00

(57) ABSTRACT

The present disclosure is directed to a cookbook for people with reading disorders. The cookbook includes a plurality of recipes. Each recipe includes at least one of at least one color-coded measurement and at least one demarcated ingredient section.

### CROSS-REFERENCE TO RELATED APPLICATION

This application claims priority to U.S. Provisional Application No. 62/711,813, filed Jul. 30, 2018, the contents of which are incorporated herein by reference in its entirety.

### BACKGROUND OF THE DISCLOSURE

The embodiments described herein generally relate to a cookbook for people with reading disorders, and, more specifically, to specially-formatted recipes with color-coded and/or shape-coded measurement labelling for ingredients and measurement tools.

Typical cookbooks and recipes have formats/layouts that are difficult for individuals with a reading disorder to read or interpret. This makes it challenging for those individuals to work independently in the kitchen and to enjoy cooking for themselves or others. There is a need, therefore, to provide a cookbook and recipes to accommodate individuals with reading disorders that make reading and interpreting each recipe easier. The present disclosure achieves these benefits by providing specially-formatted recipes including features such as color-coded and/or shape-coded measurement designations/labels, demarcated ingredient sections, directional arrows, and bulleted instructions. The system disclosed herein also provides for color-coded and/or shape-coded measurement identifiers configured to correspond to the color-coded and/or shape-coded measurement labels. Color-coded and/or shape-coded measurements include cup measures (e.g., 1 cup, ½ cup, ⅓ cup, ¼ cup, and ⅛ cup) and tablespoon (T) and teaspoon (tsp) measures (e.g., 1 T, ½ T, 1 tsp, ¾ tsp, ½ tsp, ¼ tsp, and ⅛ tsp).

### BRIEF DESCRIPTION OF THE DISCLOSURE

In one embodiment of the present disclosure, a cookbook is disclosed. The cookbook includes a plurality of recipes. Each recipe includes at least one color-coded measurement and at least one demarcated ingredient section.

In another embodiment of the present disclosure, a recipe is disclosed. The recipe includes at least one of the following: at least one color-coded measurement and at least one demarcated ingredient section.

In yet another embodiment of the present disclosure, a method for preparing a recipe is disclosed. The method includes using a cookbook comprising a plurality of recipes. Each recipe includes at least one color-coded measurement and at least one demarcated ingredient section. The method further includes preparing at least one ingredient according to a respective color-coded measurement.

In yet another embodiment, the recipe further includes measurements that are not color-coded and includes ingredients having non color-coded measurements. In these embodiments, the recipe still includes at least one demarcated ingredient section and optionally at least one assembly section, directional arrow, bullet point, action-dividing line, recipe information, image, shopping list, clickable shopping list, clickable ingredient, voice or video button, video clip, audio clip, edge design, and/or page border design.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B depict an exemplary embodiment of a recipe for tater tot casserole in accordance with the present disclosure. FIGS. 1C and 1D are an exemplary embodiment of the recipe shown in FIGS. 1A and 1B with reference numbers added in accordance with the present disclosure.

FIGS. 2A and 2B depict an exemplary embodiment of a recipe for carrot cake in accordance with the present disclosure.

FIGS. 3A and 3B depict an exemplary embodiment of a recipe for green bean casserole in accordance with the present disclosure.

FIG. 4 depicts an exemplary embodiment of a recipe for lemon chicken in accordance with the present disclosure.

FIGS. 5A and 5B depict an exemplary embodiment of a recipe for cinnamon rolls in accordance with the present disclosure.

FIGS. 6A and 6B depict an exemplary embodiment of a recipe for glazed brussel sprouts in accordance with the present disclosure.

FIG. 7 depicts an exemplary embodiment of a recipe for hash brown pork chops in accordance with the present disclosure.

FIG. 8 depicts an exemplary embodiment of a recipe for marinated pork loin in accordance with the present disclosure.

FIG. 9 depicts an exemplary embodiment of a recipe for red velvet cake in accordance with the present disclosure.

FIGS. 10A, 10B, and 10C depict exemplary embodiments of measurement identifiers in accordance with the present disclosure.

FIG. 11 depicts an exemplary embodiment of a layering feature in a recipe for tater tot casserole in accordance with the present disclosure.

FIGS. 12A and 12B depict an exemplary embodiment of a bolding feature in a recipe for tater tot casserole in accordance with the present disclosure.

FIG. 13 depicts an exemplary embodiment of a box-in-box feature in a recipe for cheesecake in accordance with the present disclosure.

### DETAILED DESCRIPTION OF THE DISCLOSURE

The embodiments described herein include a specially-formatted cookbook and recipes with color-coded and/or shape-coded measurement labels, as well as measurement tool identifiers associated with the respective color-coded and/or shape-coded measurement labels.

Reading disorders as described herein encompass, without being limited to, disorders and disabilities such as language comprehension deficits, phonological deficits, orthographic processing deficits, vocabulary weaknesses, confusion of mathematical signs and computational processes, generalized language learning disorders, and combinations thereof. Specific reading disorders include, for example, dyslexia and alexia.

In an exemplary embodiment, a cookbook includes a plurality of recipes presented in a graphic organizer style format to benefit individuals with reading disorders. Each recipe includes at least one color-coded measurement and at least one demarcated ingredient section. For instance, a measurement amount for an ingredient in the recipe is shown as the textual measurement amount and is additionally colored with an assigned color (e.g., red), such as “ [symbol] ”. A different measurement amount is colored with a different assigned color (e.g., green) than the color assigned to the “1 cup” measurement, such as “ [symbol] ”. A particular measurement amount is consistently shown with its assigned color throughout a given recipe. In an exemplary embodiment, the cookbook maintains consistent color-coded measurements across all recipes in the cookbook. For example, the color of the “1 cup” measurement is the same for all recipes in the cookbook. In some embodiments, each measurement amount is additionally or alternatively shape-coded. For example, the textual measurement amount is paired with an assigned shape (such as “▴ 1 cup” and “▪ ½ cup”). In some embodiments, the textual measurement amount is both color-coded and shape-coded (such as “ [symbol] ” and “ [symbol] ”). Depending on the embodiment, the shape itself is or is not shaded, and the shading of the shape is or is not colored. In an exemplary embodiment, a total measurement amount is shown as one or more units of each measurement amount as needed. For example, when a particular ingredient requires 2 and ½ cups, it is listed as two “1 cup” measures and one “½ cup” measure as shown here: [symbol] .

Each recipe further includes at least one demarcated ingredient section. In an exemplary embodiment, the demarcation is an open (i.e., 3-sided) square or rectangle that defines a group (or sub-group) of ingredients to be mixed, added together, and/or prepared together in some way according to the recipe. The ingredients within a demarcated ingredient section are listed with their color-coded measurement amount. Each demarcated ingredient section is configured to separate different ingredient groups from one another. In some embodiments, the lines defining the demarcated ingredient section are colored, and different sections have different-colored lines. In some embodiments, a demarcated ingredient section is arranged in a box-in-box (or double box) configuration, where a demarcated ingredient section contains two or more other demarcated ingredient sections and optionally one or more preparation steps (e.g., including one or more directional arrows as described in greater detail herein below) associated with the two or more demarcated ingredient sections contained within the box-in-box demarcated ingredient section.

In some embodiments, the recipe further includes an assembly section that shows how particular ingredients or mixtures of ingredients are to be assembled. Lines of text in the assembly section illustrate layers of the dish being prepared. For instance, in some embodiments, a tater tot casserole recipe has an assembly section that shows “tater tots/hamburger mixture/tater tots/cheese”, where each of “tater tots”, “hamburger mixture”, and “cheese” occupy a separate line in a vertical arrangement that mirrors the actual layers of the assembled dish. In some embodiments, the text corresponding to each layer is colored in order to further differentiate between the layers (e.g., “tater tots” text is yellow, “hamburger mixture” text is blue, and “cheese” text is grey). In some embodiments, the color of text corresponding to each layer also corresponds to the color of lines defining the demarcated ingredient section from which that layer came.

In some embodiments, a recipe further includes at least one additional feature. For instance, some embodiments include a directional arrow, a bullet point, recipe information, an image, a ‘master’ ingredient list (i.e., without measurement amounts), a shopping list, an audio clip, a video clip, a ‘stop’ button, a ‘next’ button, and combinations thereof.

In some embodiments, the recipe further includes at least one directional arrow that indicates a preparation step of the recipe. In some embodiments, the directional arrow is either straight or curved, and its direction indicates to a user the order of steps to follow to prepare the recipe. In some embodiments, a directional arrow extends from demarcated ingredient sections to bullet points, between demarcated ingredient sections, between bullet points, or between any other portions of the recipe to indicate a preparation step or piece of useful information. In some embodiments, the directional arrow itself has accompanying text, such as an instruction or piece of useful information. For example, a directional arrow extending from one demarcated ingredient section to another demarcated ingredient section indicates mixing the ingredients from those two sections. The location, shape, and direction of each directional arrow are configured to assist the user in reading/interpreting the recipe.

In some embodiments, the recipe further includes at least one bullet point that indicates a preparation step and/or piece of useful information for the recipe. Because the bullet points typically contain limited wording, they are beneficial for individuals who have difficulty following lines and/or large blocks of text. In some embodiments, additional instructions with limited wording are included. In some embodiments, ample spacing is provided throughout each recipe page.

In some embodiments, the recipe further includes at least one action-dividing line. The action-dividing line serves to divide or separate actions required by the recipe. The action-dividing line separates demarcated ingredient sections, bullet points, and/or directional arrows that are specific to a particular action (or group of actions) required by the recipe. As an example, in a recipe for cinnamon rolls there is an action-dividing line that separates steps of the recipe before the dough rises from steps of the recipe that happen after the dough rises. In some embodiments, the action-dividing line also includes an indicator of the amount of time separating the actions (e.g., “after 15 min”). As another example, in a recipe for marinated pork loin there is an action-dividing line that separates actions required by the recipe one day (such as marinating) from actions required on the next day (such as baking). In this example, the action-dividing line includes an indicator of the amount of time separating the recipe actions (e.g., “next day”). This feature is further exemplified in the Figures described below.

In some embodiments, the recipe further includes recipe information. Recipe information includes a number of servings, prep time, cook time, total time, oven temperature, etc. In some embodiments, the recipe further includes an image. The image is selected from an ingredient image, a preparation step image, a completed recipe image, and combinations thereof. The images enable a user to visualize ‘how to’ and ‘what it should look like’ aspects of the recipe. In some embodiments, the ingredient image is at least one different image of the ingredient, such as multiple images showing different brands and/or packaging and/or sizes of the ingredient. In some embodiments, the recipe further includes at least one shopping list for the recipe. In some embodiments, the shopping lists include at least one image of an ingredient on the list such as multiple images showing different brands and/or packaging and/or sizes of the ingredient.

In some embodiments, the cookbook is a hardcopy book. In some embodiments, the cookbook is an electronic book and configured to be displayed on an electronic device. The electronic device includes, but is not limited to, an iPad, an iPhone, an Android device, a tablet, a smart phone, a laptop computer, a desktop computer, and any electronic device with a display and/or visual interface, etc. In some embodiments, the recipe further includes an audio clip and/or a video clip. The audio/video clip(s) include preparation steps and/or other useful information associated with the recipe. In some embodiments, the audio/video clip(s) are configured to play automatically. In some embodiments, the audio/video clip(s) are configured to play upon user selection of a button on the electronic device (such as a physical button) or on the display of the electronic device (such as a virtual or touchscreen button or icon).

In some embodiments, additional electronic device buttons or icons include a ‘next’ button (such as a next/go/play/advance/forward type button) that allows a user to advance through a visually displayed progression of ingredients and/or steps of a recipe, as well as a ‘stop’ button that allows a user to stop or pause the visually displayed progression of the ingredients and/or steps of the recipe. For example, upon selection of the next button, an ingredient and/or step of the recipe will be visually emphasized (as discussed in greater detail herein below). Subsequent ingredients and/or steps of the recipe are visually emphasized either automatically or manually. In embodiments where subsequent ingredients and/or steps are visually emphasized automatically, a first ingredient (or group of ingredients) and/or step (or group of steps) is emphasized for a certain amount of time after which the first ingredient/step becomes deemphasized and a second (or next, such as according to a progression of the recipe) ingredient/step becomes emphasized for a certain amount of time. In embodiments where subsequent ingredients and/or steps are visually emphasized manually, a user must select the ‘next’ button each time they want to change visual emphasis of ingredients/steps (such as according to a progression of the recipe). In some embodiments, a ‘back’ or ‘previous’ button is also included on the electronic device (or on a display of the electronic device) that allows a user to visually emphasize previous or earlier ingredients/steps of the recipe. For example, in some embodiments, a triangular-shaped button and a stop sign button are used. When a user clicks on the triangular-shaped button, a particular step in the recipe is slightly bolded and every time the user clicks the triangular-shaped button after that, it will operate as a “next” button and moves the user through the recipe. This will also include any actions necessary regarding boxes, arrows with instructions (e.g., “mix in mixer”), etc. To end the recipe, a user clicks the stop sign.

In some embodiments, a printable version of the cookbook is associated with the electronic cookbook. In some embodiments of the electronic cookbook, the shopping list is ‘clickable’ such that a user clicks on (or selects) an ingredient on the shopping list to view one or more images of that particular ingredient. Additionally or alternatively, an ingredient within the recipe itself is ‘clickable’ such that a user clicks on (or selects) an ingredient listed within the recipe itself to view one or more images of that particular ingredient.

In some embodiments, each recipe of the cookbook includes a specific edge design or page border design that is based on a category of the dish/recipe. For example, “main dish” (e.g., entrée, etc.) recipes have a different edge/border design than dessert recipes.

In some embodiments, the recipe further includes measurements that are not color-coded. For example, the recipe includes ingredient measurements that do not require a color-coded measurement, such as 2 lb (1 bag) frozen tater tots, 2 lb hamburger, salt & pepper, ¼ onion (cut up), 12 oz. (1 bag) frozen corn, 3 eggs, 1½ sticks butter, 43.5 oz. (3 cans) green beans, 3 chicken breasts, juice of 2 lemons, 1 package dry yeast, etc. In some embodiments, the recipe only includes ingredients having non color-coded measurements. That is, in some embodiments, the recipe does not include at least one color-coded measurement. In these embodiments, the recipe still includes at least one demarcated ingredient section and optionally at least one assembly section, directional arrow, bullet point, action-dividing line, recipe information, image, shopping list, clickable shopping list, clickable ingredient, voice or video button, video clip, audio clip, edge design, and/or page border design, as described above.

In some embodiments, measurement identifiers are additionally included with the cookbook. The measurement identifiers are color-coded and associated with a respective color-coded measurement. For example, a set of colored zip ties is provided with the cookbook which the user attaches to the corresponding measurement tool according to the color-coding of the cookbook recipe measurements. In some embodiments, an illustration is provided to show a user how to match measuring tool sizes with their respective color-coded identifier according to the recipe or cookbook. As another example, a set of colored stickers or tape is provided with the cookbook. In some embodiments, the identifiers are further shape-coded. In some embodiments, at least one set of measurement tools is additionally provided with the cookbook wherein the measurement identifiers are integrated into the measurement tools themselves, such as by incorporating a colored label onto measuring cups and spoons, incorporating colored lines or markings onto liquid measuring tools, or by coloring all or part of the measuring tool (e.g., the handle only, the measurement end only, or the entire tool). For example, colored sets of measurement cups (such as 1 cup, ½ cup, ⅓ cup, ¼ cup, and ⅛ cup measures) and spoons (such as 1 T, ½ T, 1 tsp, ¾ tsp, ½ tsp, ¼ tsp, and ⅛ tsp measures) are provided with the cookbook. In some embodiments, a liquid measuring tool (or tools) is also provided with the cookbook. In some embodiments, the measurement identifiers on the liquid measuring tool correspond (i.e., have the same color and/or shape) to the dry measuring tool identifier having the same size measurement. In other embodiments, the measurement identifiers on the liquid measuring tool do not correspond (i.e., do not have the same color and/or shape) to the dry measuring tool identifier of the same size measurement.

In embodiments where the cookbook or recipes are displayed electronically, such as in an electronic book, one or more graphical effects or visual features are included, such as visually emphasizing features that are configured to draw attention to or highlight various components of a recipe. In some embodiments, a visually emphasizing feature is in the form of layering, such as in recipes that include an assembly section illustrating layers of a dish being prepared. In these embodiments, a user selects (e.g., touches) a layer listed in the assembly section of the recipe and the layering feature is activated by dimming (or visually deemphasizing in some other way) ingredients and/or steps of the recipe that are not associated with preparation of the selected layer. Consequently, the ingredients and/or steps associated with the selected layer are visually emphasized on the electronic display, such as for convenience to the user when preparing that particular layer of the dish. In some embodiments, a subsequent selection (e.g., touch) of the assembly section layer deactivates the layering feature. Another layer listed in the assembly section can then be selected for visual emphasis via the layering feature. In some embodiments, the layering feature is activated and deactivated manually or automatically. In some embodiments, the layering feature is available for other recipe components (e.g., ingredients, preparation steps, bullet points, etc.) that are not part of an assembly section of a recipe. In some embodiments, the layering feature is used concurrently with other graphical effects and/or visually emphasizing features.

In some embodiments, a visually emphasizing feature is in the form of bolding. In these embodiments, a user selects (e.g., touches) an ingredient or step and the bolding feature is activated, such that the selected item text becomes bold and thus visually emphasized over other items on the electronic display of the recipe. In some embodiments, a subsequent selection (e.g., touch) of the item deactivates the bolding feature. In some embodiments, the bolding feature is activated and deactivated manually or automatically. In some embodiments, visual emphasis of recipe components is additionally or alternatively indicated by highlighting (such as colored highlighting) effects, encircling effects, dimming/brightening effects, enlarging/shrinking effects, pointer/indicator effects, etc. In some embodiments, the bolding feature is available for other recipe components (e.g., preparation steps, assembly section layers, etc.) alternatively or in addition to recipe ingredients. In some embodiments, the bolding feature is used concurrently with other graphical effects and/or visually emphasizing features. Various features disclosed herein are further exemplified in the Figures described below.

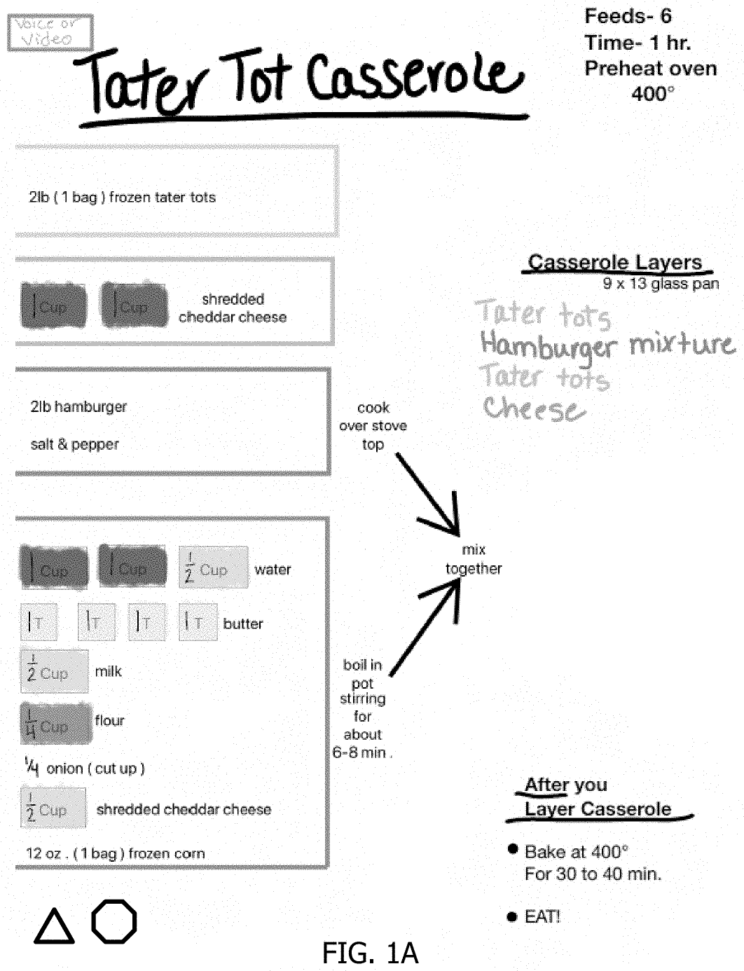

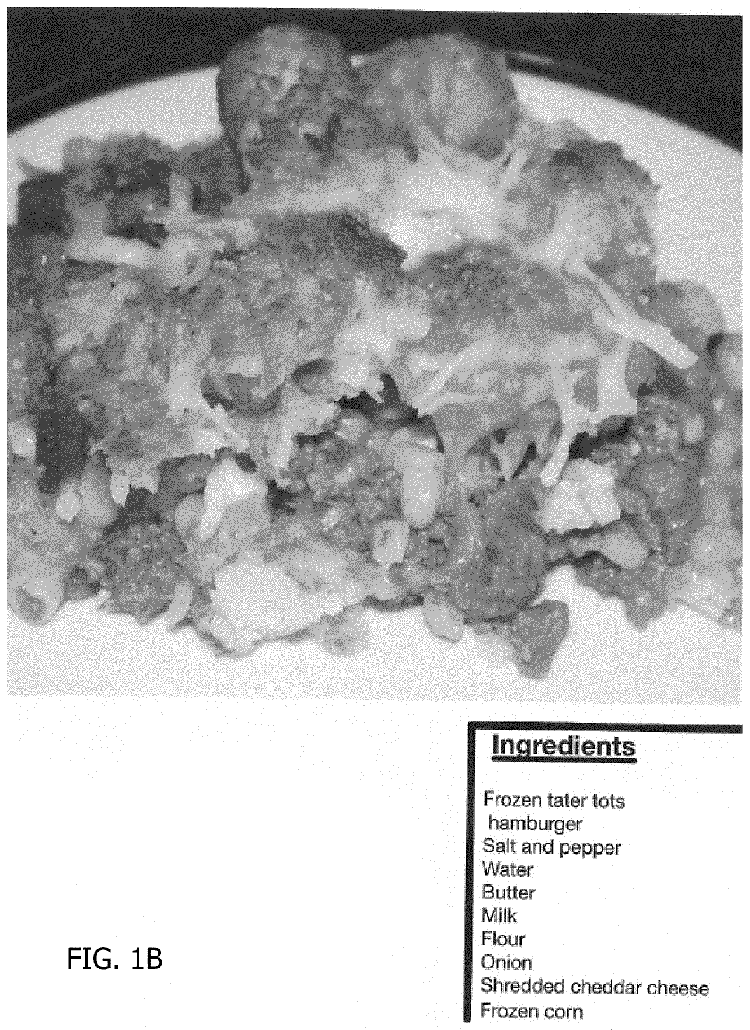

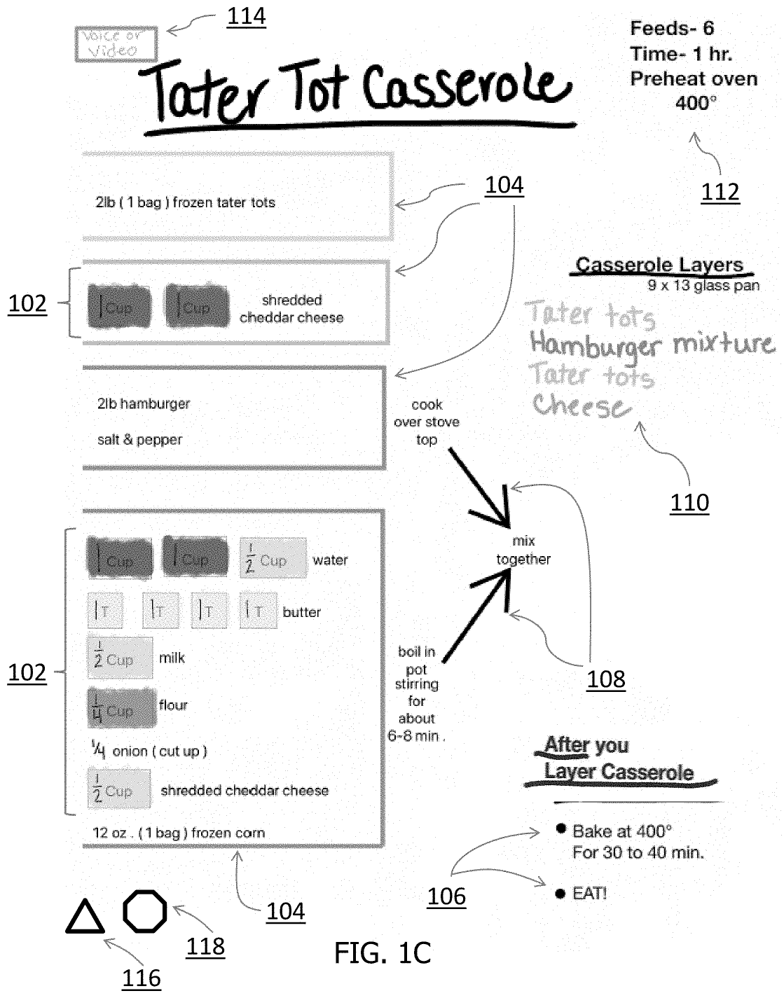

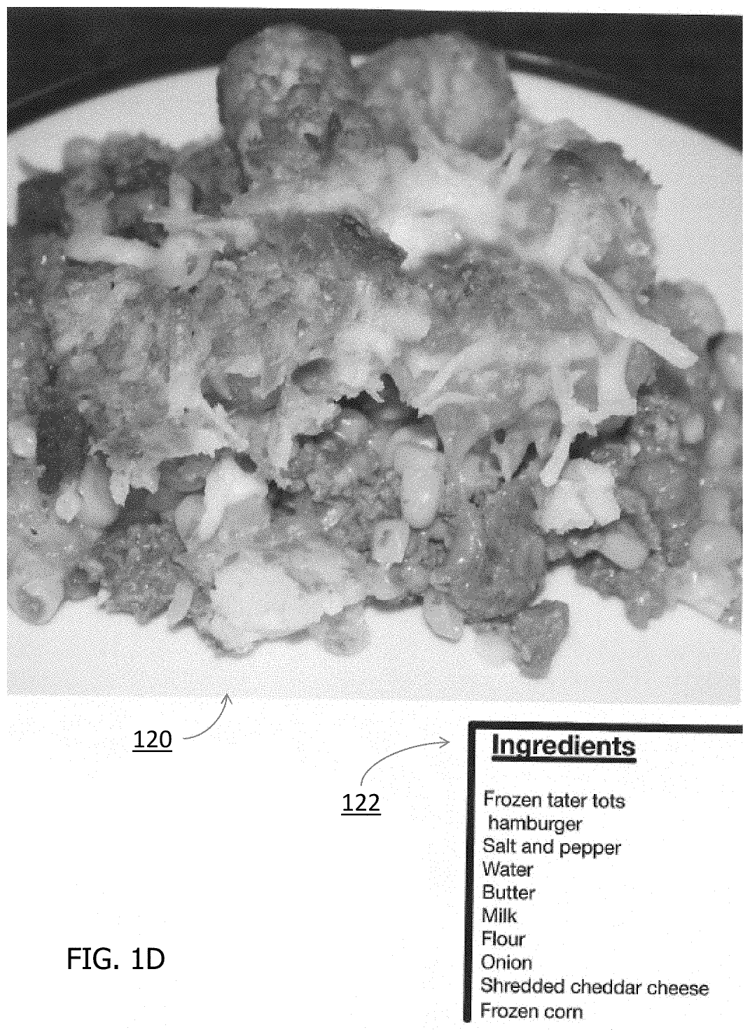

FIGS. 1A and 1B show an exemplary embodiment of a recipe for tater tot casserole in accordance with the present disclosure. FIGS. 1C and 1D show the recipe for tater tot casserole with reference numbers to be described herein below. In FIG. 1C, color-coded measurement amounts 102 are shown for various ingredients. Demarcated ingredient sections 104 are used to demarcate and separate four sets/groups of ingredients and are shown with colored lines. The line color of each demarcated ingredient section 104 corresponds to a casserole layer illustrated in assembly section 110. Assembly section 110 utilizes both text and color to indicate each layer. Bullet points 106 show various preparation steps for the recipe. Directional arrows 108 are straight in this particular embodiment and indicate ingredients that are to be mixed. The tater tot casserole recipe further includes recipe information 112, a ‘voice or video’ button 114 (e.g., in embodiments where the cookbook/recipe is in an electronic form), and ample spacing. Additional buttons include a ‘next’ button 116 and a ‘stop’ button 118 (e.g., in embodiments where the cookbook/recipe is in an electronic form). In FIG. 1D, the tater tot casserole recipe further includes an image 120, a shopping list 122, non-color-coded measurements, and ample spacing. Image 120 shows an image of the finished dish/recipe.

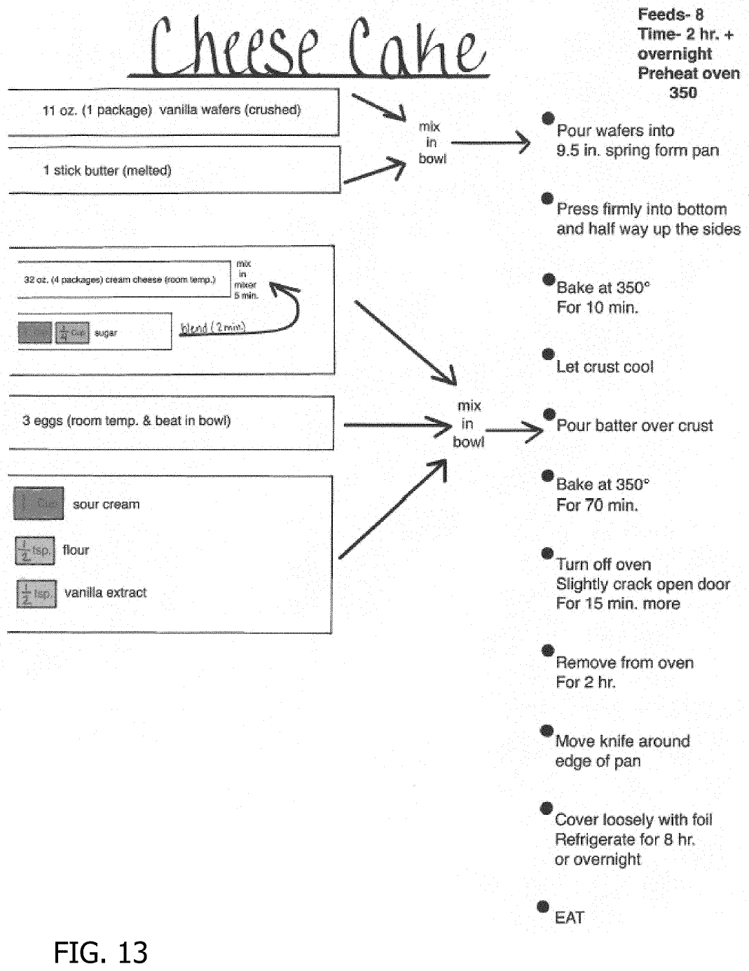

FIG. 13 shows an exemplary embodiment of a box-in-box feature in a recipe for cheesecake in accordance with the present disclosure. In some embodiments, a demarcated ingredient section is arranged in a box-in-box (or double box) configuration, where a demarcated ingredient section contains two or more other demarcated ingredient sections and optionally one or more preparation steps (e.g., including one or more directional arrows as described in greater detail herein below) associated with the two or more demarcated ingredient sections contained within the box-in-box demarcated ingredient section. In the embodiment shown, two demarcated ingredient sections (cream cheese and sugar) are shown in a box-in-box demarcated ingredient section configuration, along with preparation steps (‘mix in mixer 5 min.’ and ‘blend’) and a directional arrow associated with the two ingredients contained within the box-in-box demarcated ingredient section. In addition to demarcated ingredient sections (e.g., both box-in-box (i.e., double box) and non-box-in-box (i.e., single box)), FIG. 13 also includes color-coded measurements, bullet points, directional arrows, recipe information, non-color-coded measurements, and ample spacing.

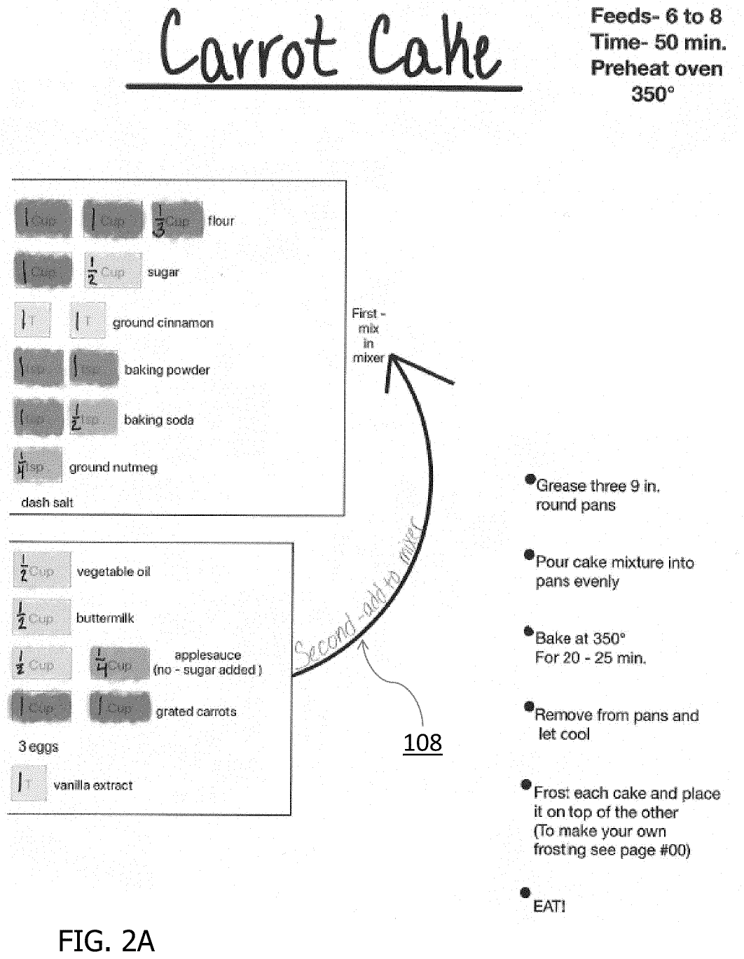

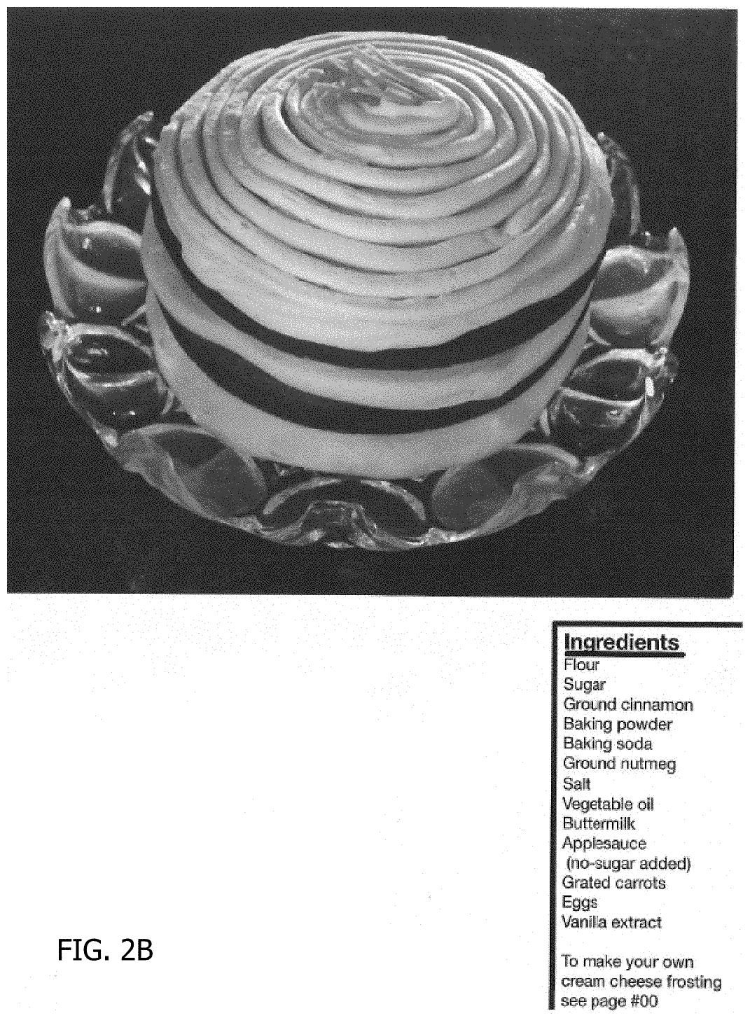

FIGS. 2A and 2B show an exemplary embodiment of a recipe for carrot cake in accordance with the present disclosure. FIG. 2A includes color-coded measurement amounts, demarcated ingredient sections, bullet points, a directional arrow 108 (which is curved in this particular embodiment), recipe information, non-color-coded measurements, and ample spacing. FIG. 2B includes an image of the finished dish, a shopping list, and ample spacing.

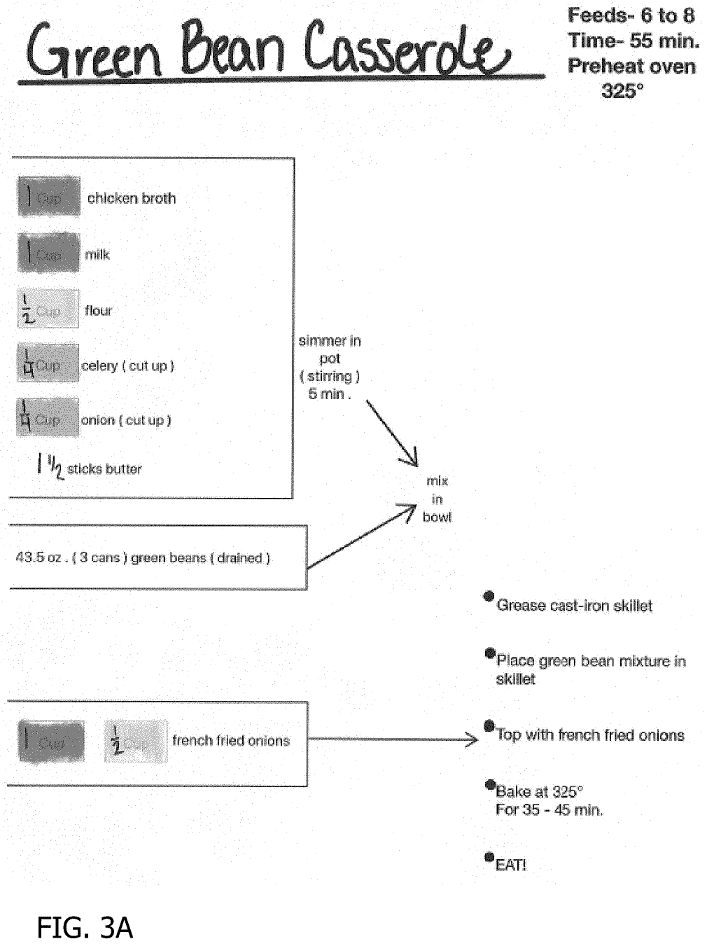

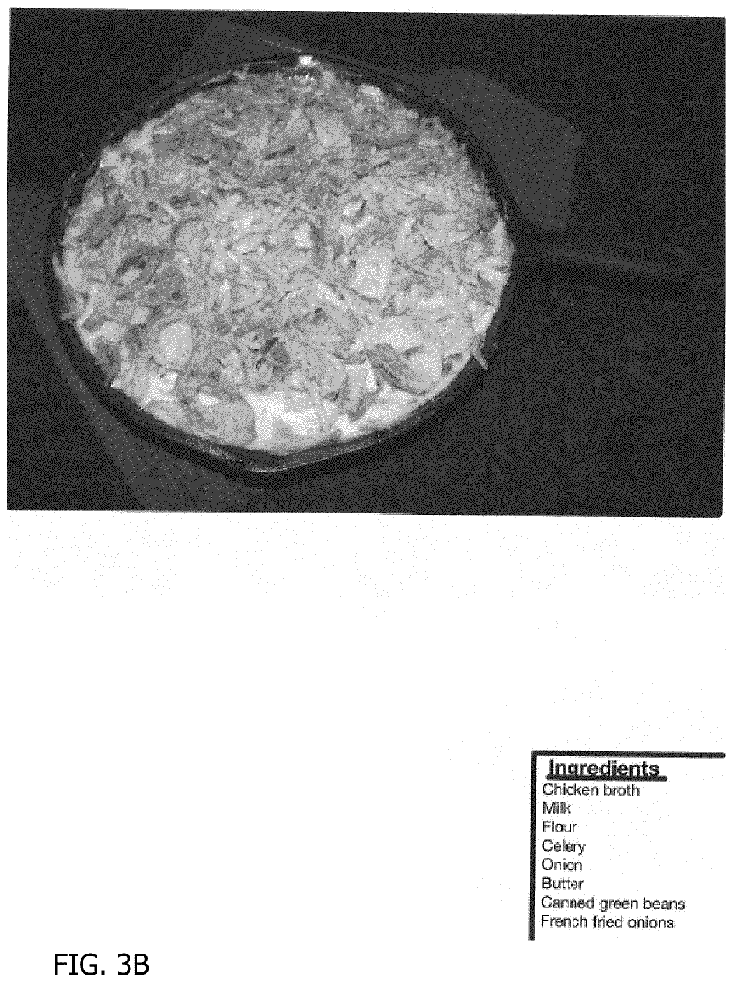

FIGS. 3A and 3B show an exemplary embodiment of a recipe for green bean casserole in accordance with the present disclosure. FIG. 3A includes color-coded measurement amounts, demarcated ingredient sections, bullet points, directional arrows, recipe information, non-color-coded measurements, and ample spacing. FIG. 3B includes an image of the finished dish, a shopping list, and ample spacing.

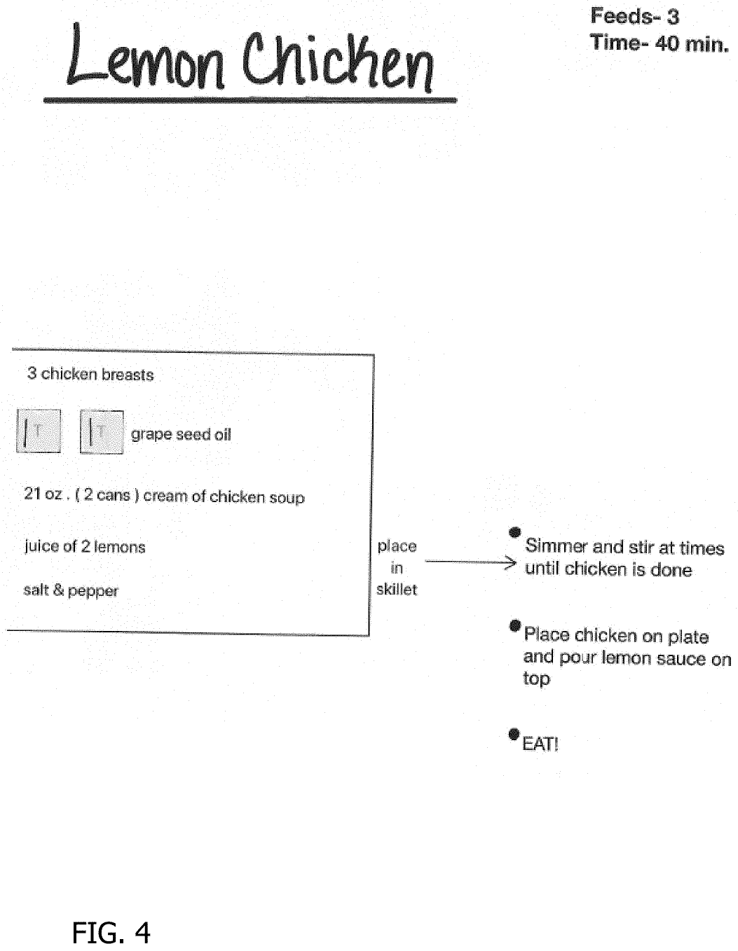

FIG. 4 shows an exemplary embodiment of a recipe for lemon chicken in accordance with the present disclosure. FIG. 4 includes color-coded measurement amounts, a demarcated ingredient section, a directional arrow, bullet points, recipe information, non-color-coded measurements, and ample spacing.

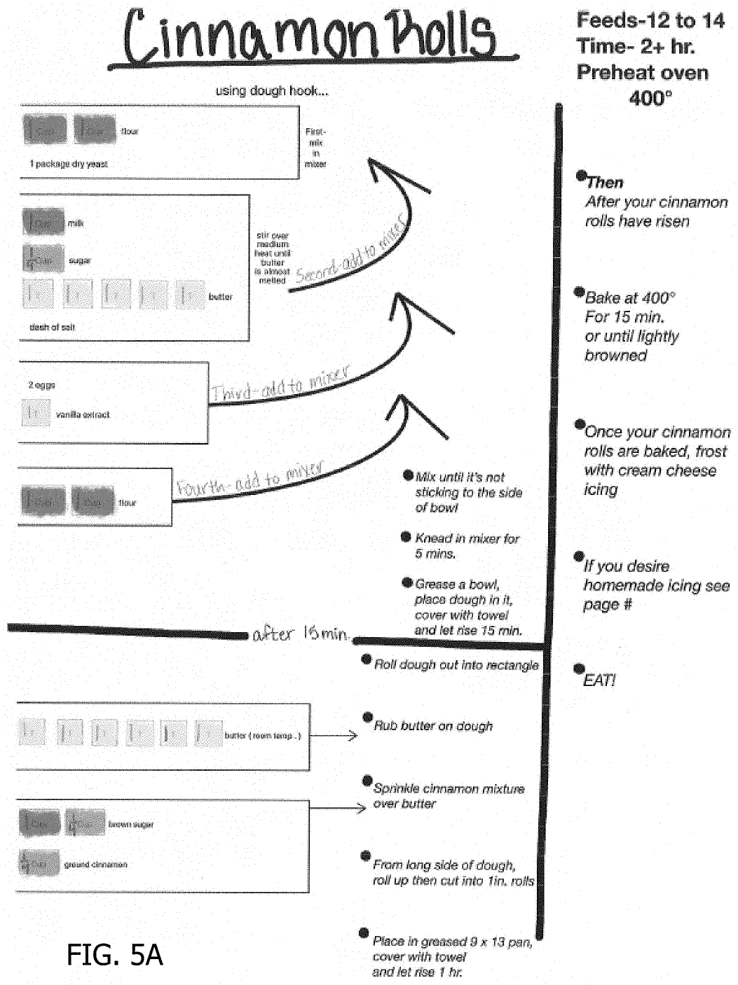

FIGS. 5A and 5B show an exemplary embodiment of a recipe for cinnamon rolls in accordance with the present disclosure. FIG. 5A includes color-coded measurement amounts, demarcated ingredient sections, bullet points, directional arrows, action-dividing lines, recipe information, non-color-coded measurements, and ample spacing. FIG. 5B includes multiple preparation step images with limited text, a finished dish image, a shopping list, and ample spacing.

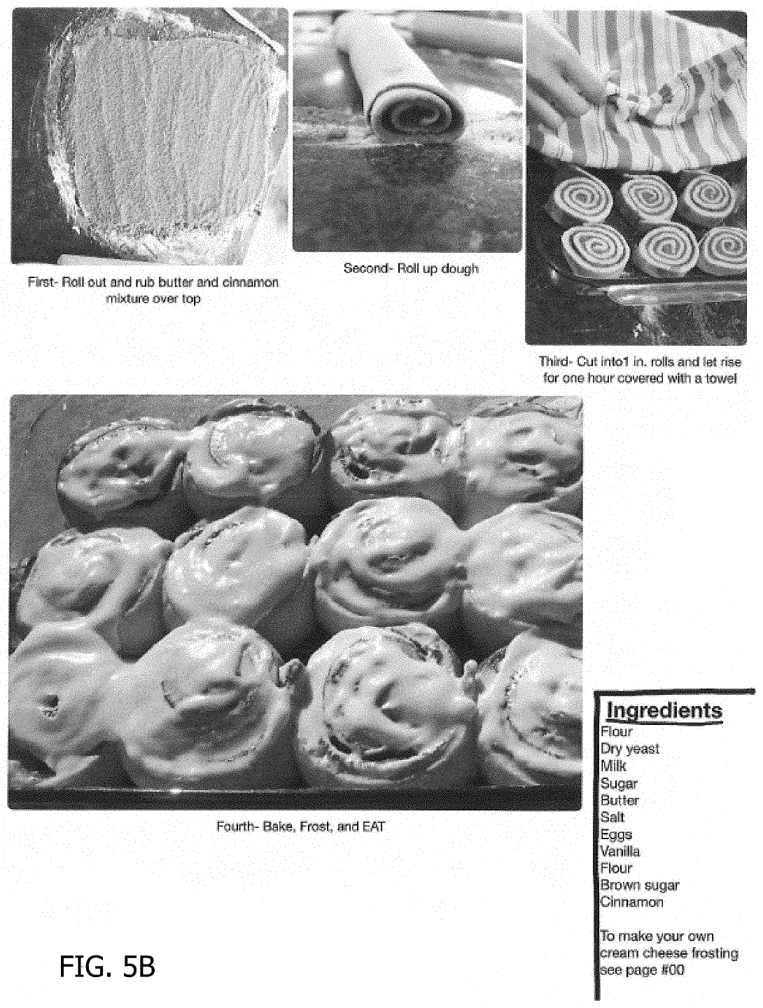

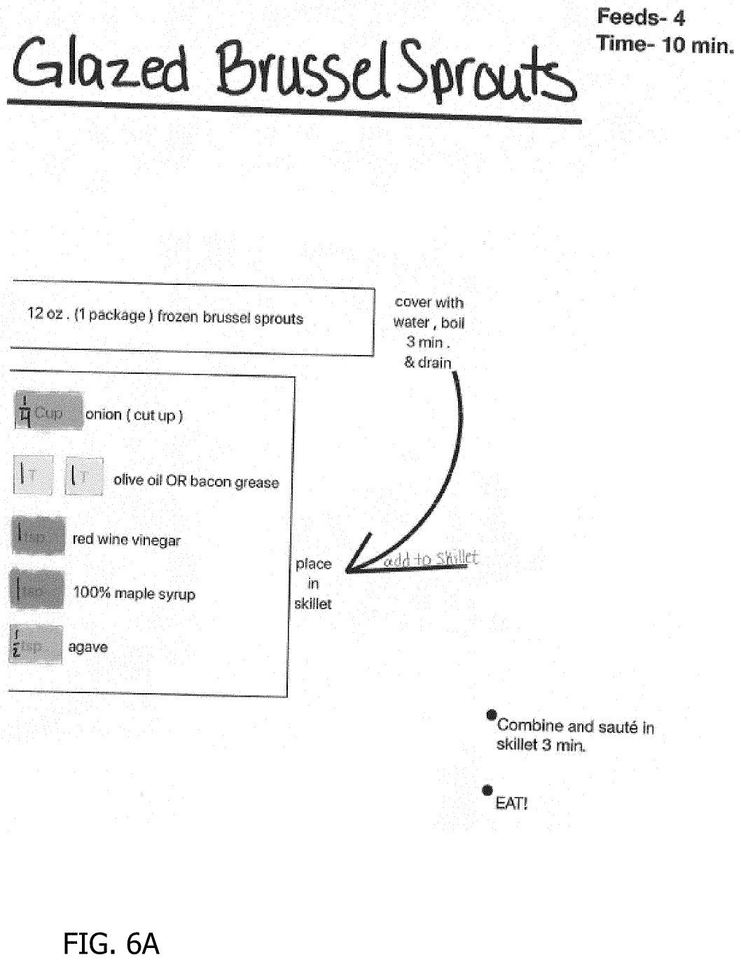

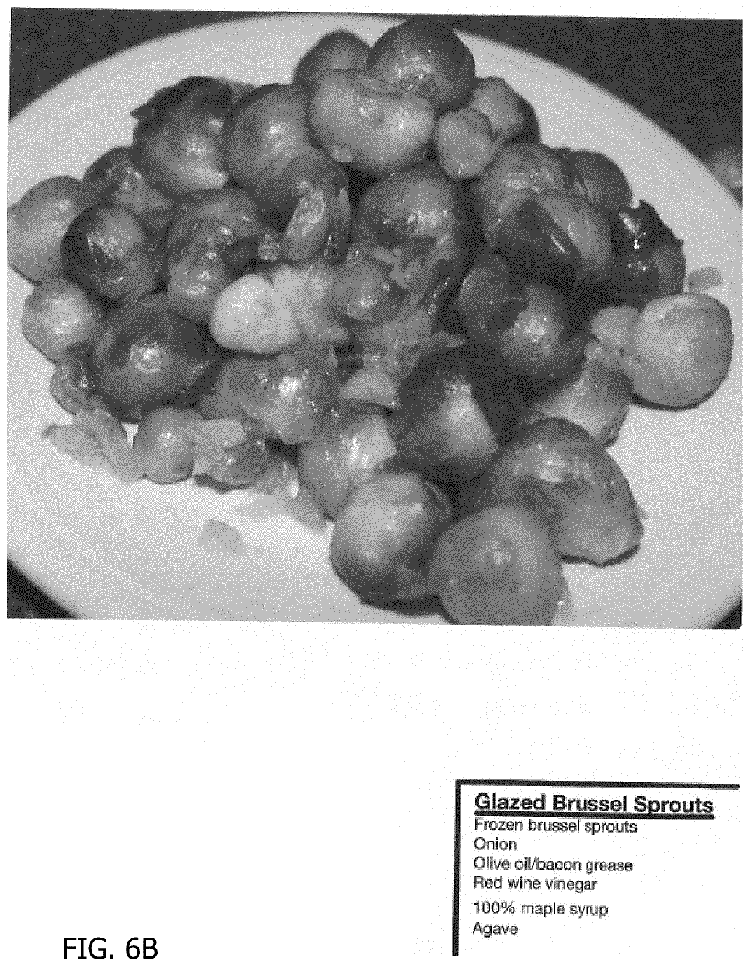

FIGS. 6A and 6B show an exemplary embodiment of a recipe for glazed brussel sprouts in accordance with the present disclosure. FIG. 6A includes color-coded measurement amounts, demarcated ingredient sections, bullet points, a directional arrow, recipe information, a non-color-coded measurement, and ample spacing. FIG. 6B includes a finished dish image, a shopping list, and ample spacing.

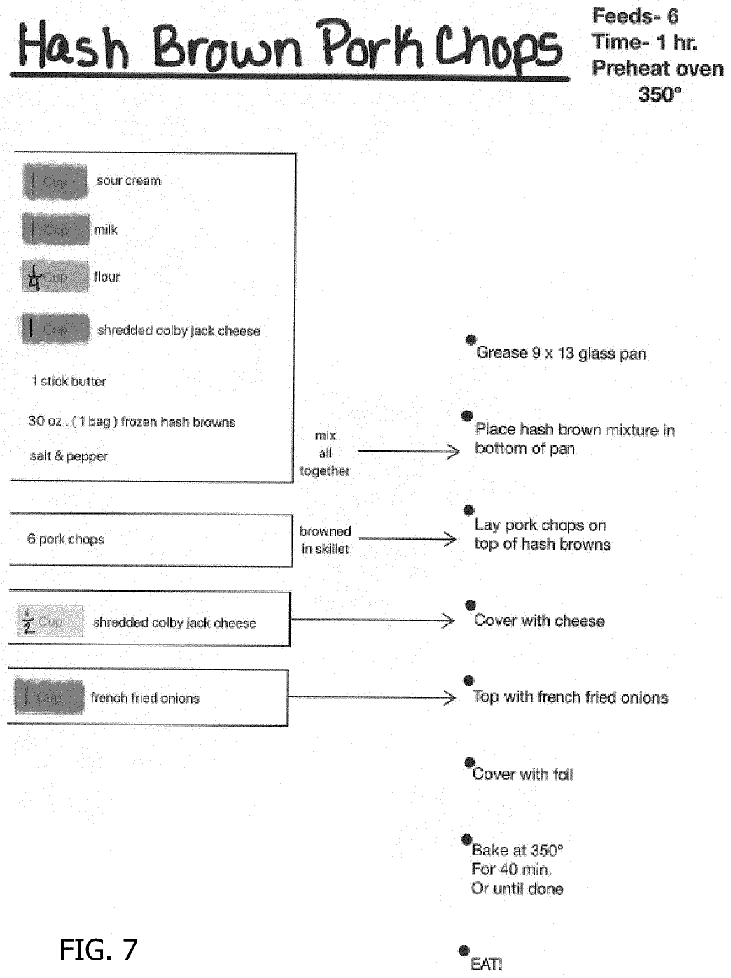

FIG. 7 shows an exemplary embodiment of a recipe for hash brown pork chops in accordance with the present disclosure. FIG. 7 includes color-coded measurement amounts, demarcated ingredient sections, bullet points, directional arrows, recipe information, non-color-coded measurements, and ample spacing.

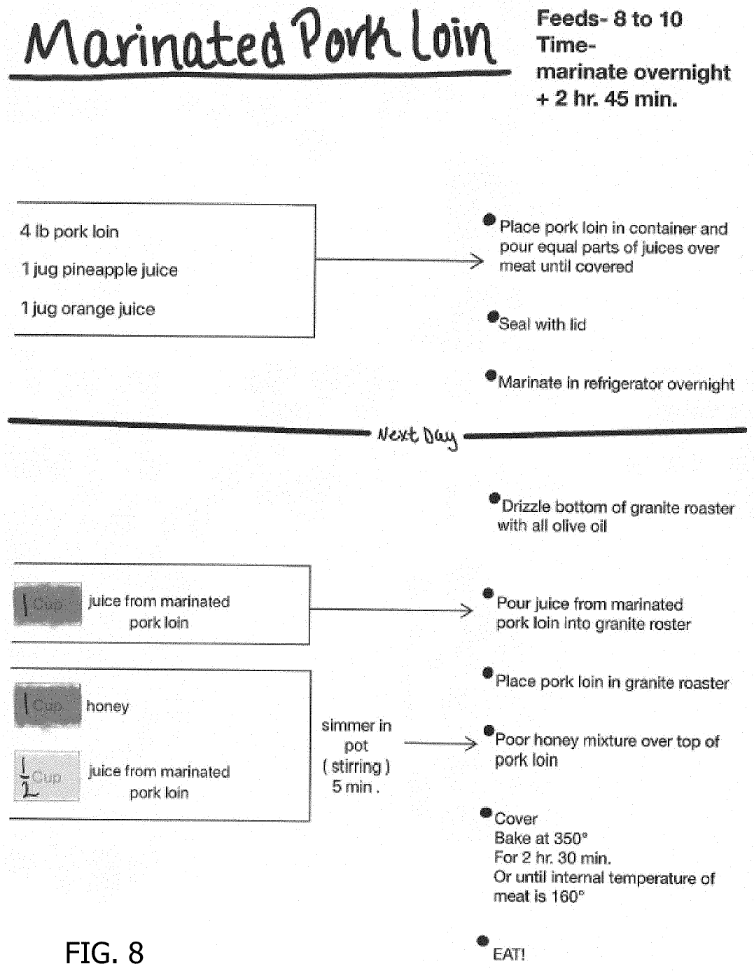

FIG. 8 shows an exemplary embodiment of a recipe for marinated pork loin in accordance with the present disclosure. FIG. 8 includes color-coded measurement amounts, demarcated ingredient sections, bullet points, directional arrows, an action-dividing line, recipe information, non-color-coded measurements, and ample spacing.

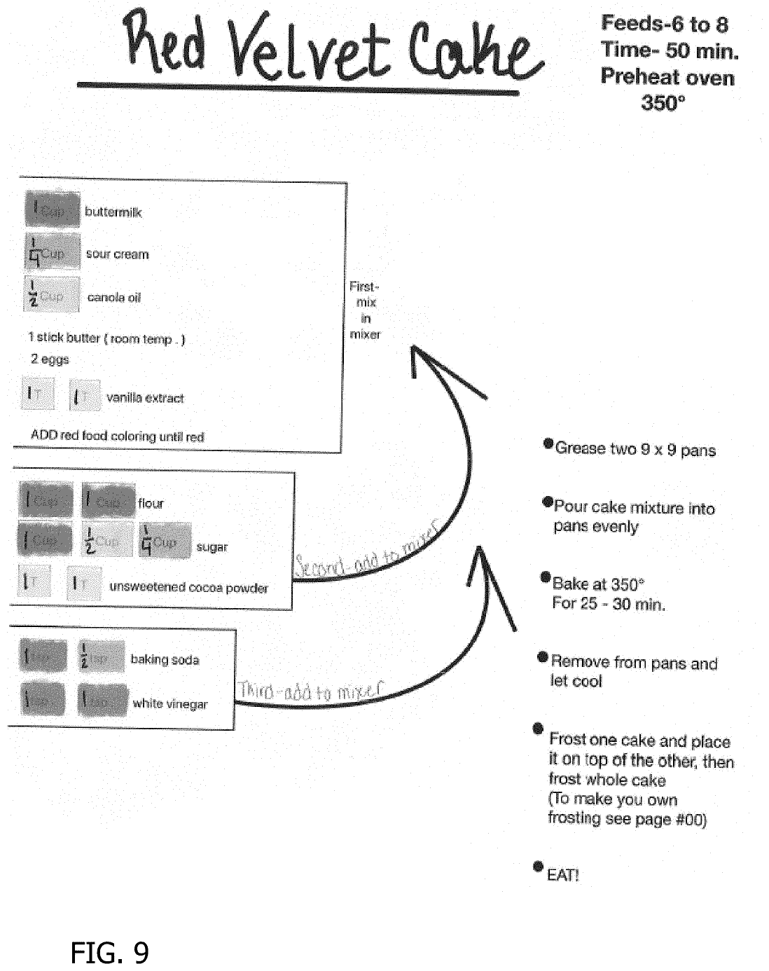

FIG. 9 shows an exemplary embodiment of a recipe for red velvet cake in accordance with the present disclosure. FIG. 9 includes color-coded measurement amounts, demarcated ingredient sections, bullet points, directional arrows, recipe information, non-color-coded measurements, and ample spacing.

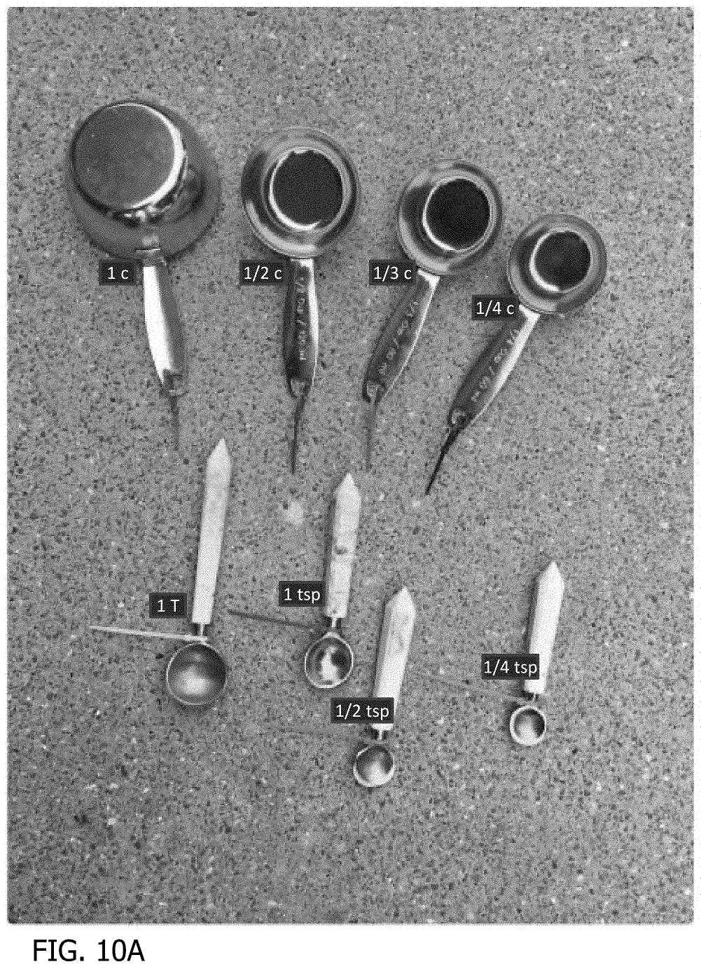

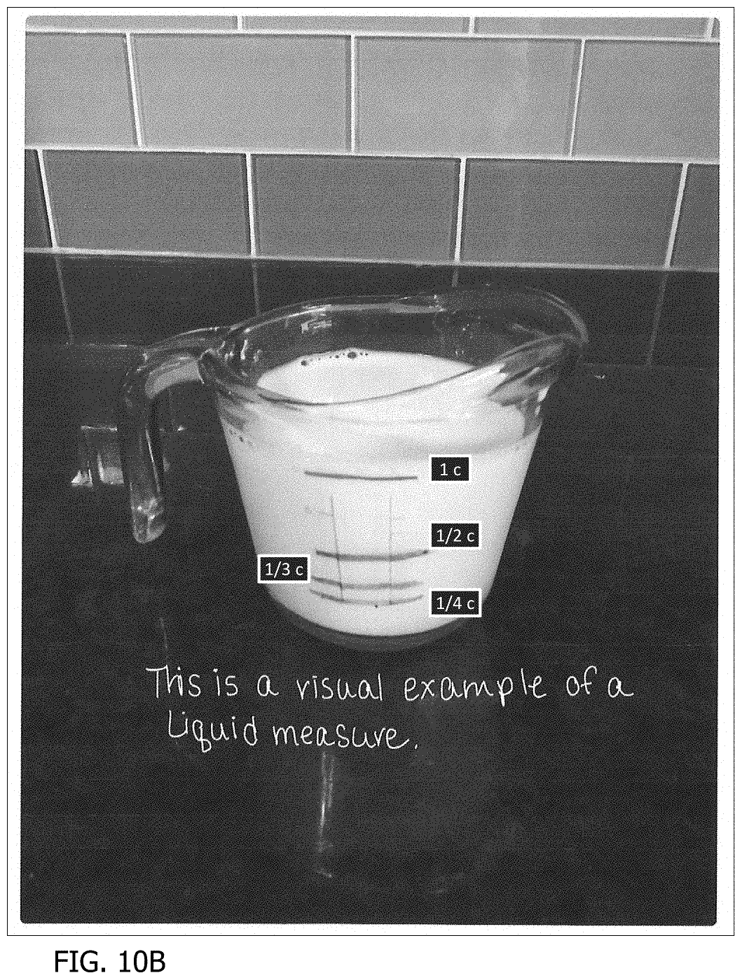

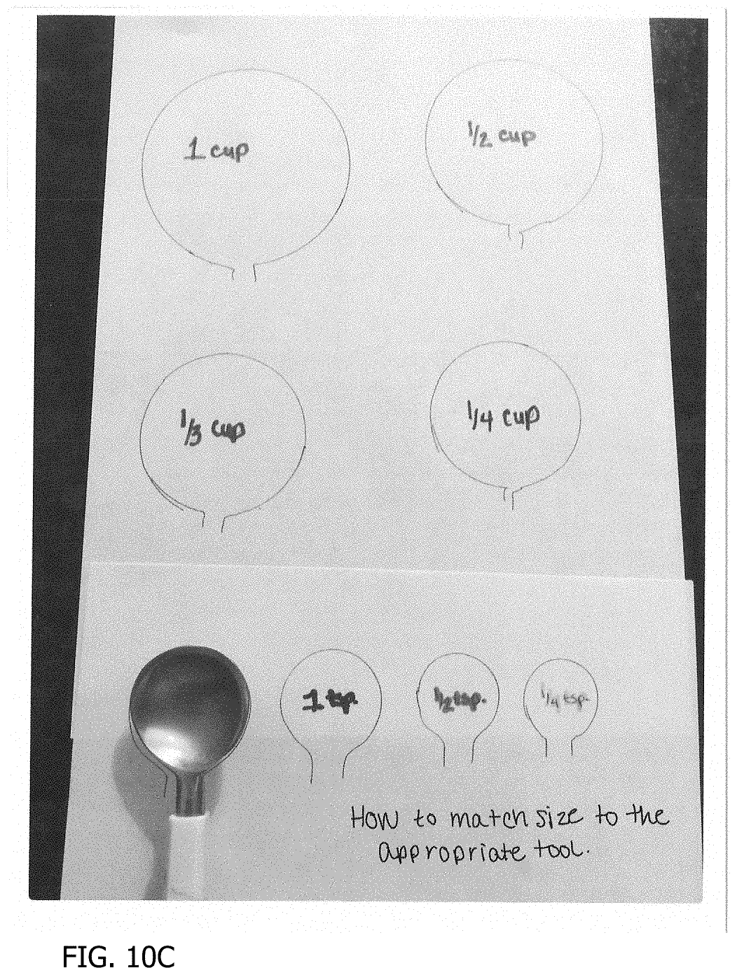

FIGS. 10A-C show exemplary embodiments of measurement identifiers in accordance with the present disclosure. FIG. 10A shows colored zip ties attached to the respective measurement tool according to the color-coded measurement amount shown in the recipes of FIGS. 1-10. FIG. 10B shows liquid measurement identifiers integrated into the respective measurement tool according to the color-coded measurement amount shown in the recipes of FIGS. 1-10. In some embodiments, the measurement identifiers on the liquid measuring tool correspond (i.e., have the same color and/or shape) to the dry measuring tool identifier having the same size measurement. FIG. 10C shows how to match a measurement tool to a respective color in order to attach the color-coded measurement identifiers. For example, when colored zip ties are provided as the measurement identifiers, an illustration similar to that shown in FIG. 10C is also provided to the user for aid in matching measuring tool sizes with their respective color-coded identifier according to the recipe or cookbook.

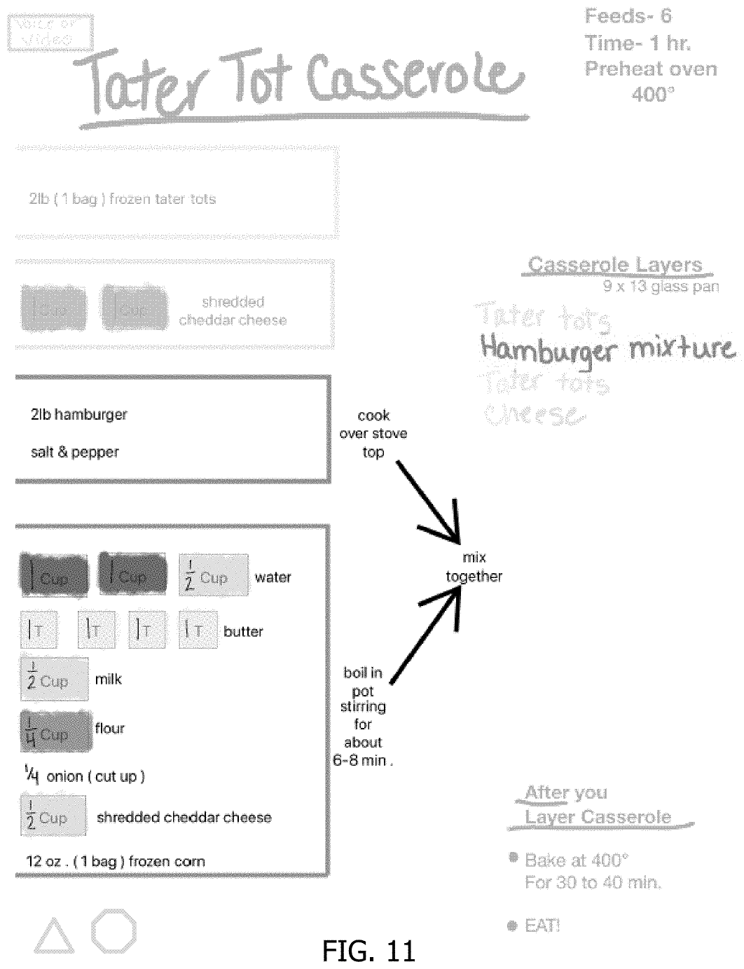

FIG. 11 shows an exemplary embodiment of a layering feature in a recipe for tater tot casserole in accordance with the present disclosure. Prior to activation of the layering feature, graphical elements including text, shapes, lines, color, etc. appear as shown in FIG. 1A. Following activation of the layering feature (e.g., by selecting a layer listed in the assembly section of a recipe displayed on an electronic device and/or as part of an electronic cookbook), a particular layer of an assembly section, such as the ‘hamburger mixture’ layer is essentially highlighted or visually emphasized by dimming the components of the recipe that are not directly associated with the hamburger mixture. In some embodiments, upon deactivation of the layering feature, such as by selecting the ‘hamburger mixture’ layer again, the entire recipe components become equally visible with the hamburger mixture and its associated ingredients and/or preparation steps (as shown in FIG. 1A).

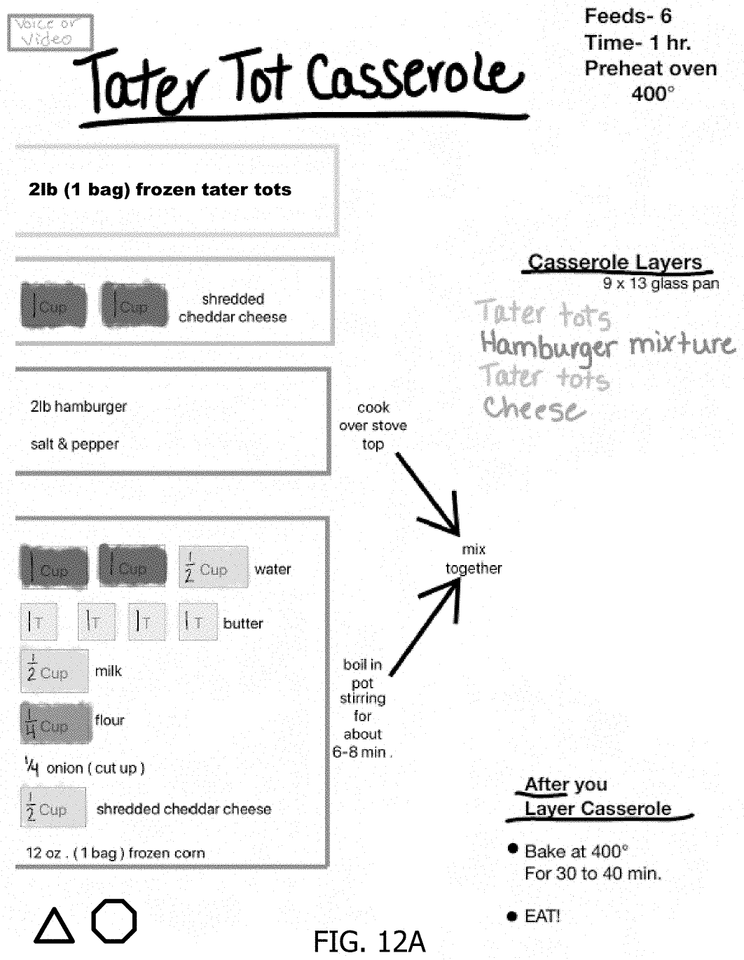

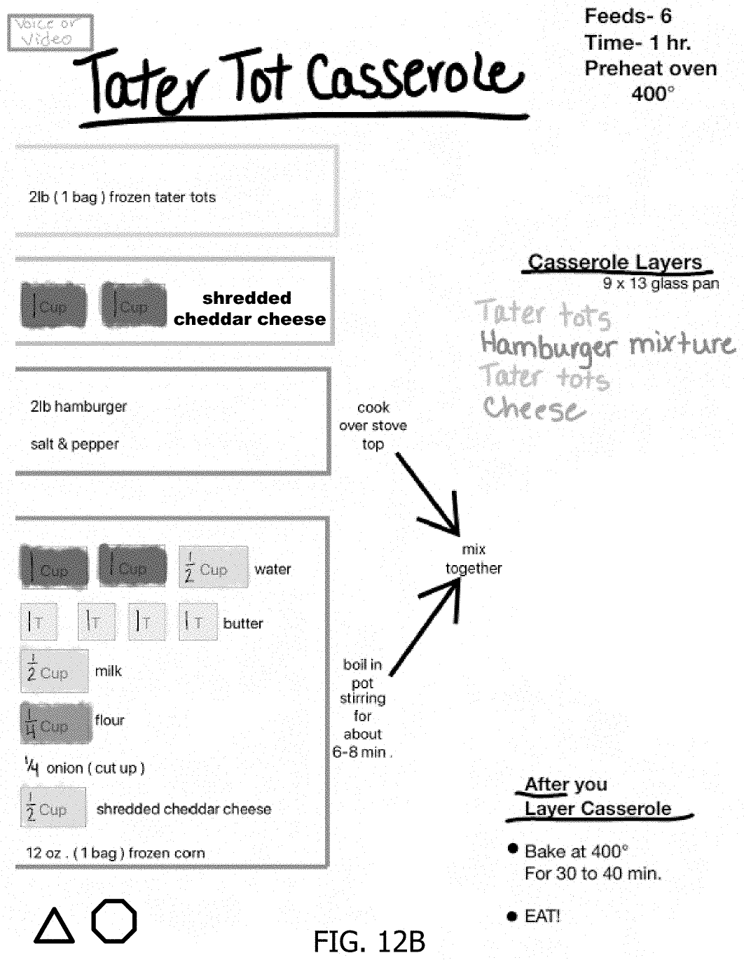

FIGS. 12A and 12B show an exemplary embodiment of a bolding feature in a recipe for tater tot casserole in accordance with the present disclosure. Prior to activation of the bolding feature, graphical elements including text, shapes, lines, color, etc. appear as shown in FIG. 1A. Following activation of the bolding feature (e.g., by selecting an ingredient or a ‘next’ button of a recipe displayed on an electronic device and/or as part of an electronic cookbook), a particular ingredient and its corresponding measurement becomes bolded and/or visually larger and/or highlighted (e.g., by a text color change, by a text background color change, etc.). FIG. 12A shows the ingredient ‘2 lb (1 bag) frozen tater tots’ in bolded text. In some embodiments, the bolded ingredient becomes un-bolded either manually (e.g., by selecting the ingredient by touching) or automatically after a certain amount of time as described herein above. Another ingredient of the recipe, such as the next listed ingredient (and its corresponding measurement), can subsequently be bolded upon either manual activation (e.g., by touching the ingredient) or automatically following un-bolding of a previous ingredient. FIG. 12B shows a subsequent recipe display where the ‘2 lb (1 bag) frozen tater tots’ is un-bolded and the next ingredient ‘shredded cheddar cheese’ is now bolded.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A cookbook comprising:
a plurality of recipes, wherein each recipe includes:
at least one color-coded measurement; and
at least one demarcated ingredient section.

2. The cookbook of claim 1, wherein the at least one color-coded measurement is further shape-coded.

3. The cookbook of claim 1, wherein at least one image is displayed with at least one of the plurality of recipes and wherein the at least one image is selected from an ingredient image, a preparation step image, a completed recipe image, and combinations thereof.

4. The cookbook of claim 1, wherein at least one recipe of the plurality of recipes further comprises at least one of a directional arrow indicating a preparation step of the recipe, a demarcated ingredient section demarcated by color, a demarcated ingredient section demarcated by lines, and combinations thereof.

5. The cookbook of claim 1, wherein the cookbook is an electronic book configured to be displayed on an electronic device and wherein the cookbook further comprises at least one of a video clip, an audio clip, a next button, a stop button, a layering feature, a bolding feature, and combinations thereof.

6. The cookbook of claim 1, further comprising at least one shopping list associated with at least one of the plurality of recipes.

7. The cookbook of claim 1, wherein the cookbook is configured for users with at least one of a reading disorder, a language comprehension deficit, a phonological deficit, an orthographic processing deficit, a vocabulary weakness, and a generalized language learning disorder, and wherein the reading disorder comprises at least one of dyslexia and alexia.

8. The cookbook of claim 1, further comprising at least one color-coded identifier, wherein each identifier is associated with a color-coded measurement, and wherein the color-coded identifiers comprise at least one of colored stickers and colored zip ties.

9. A recipe comprising at least one of the following:
at least one demarcated ingredient section; and
at least one color-coded measurement.

10. The recipe of claim 9, wherein the at least one color-coded measurement is further shape-coded.

11. The recipe of claim 9, wherein the recipe does not include at least one color-coded measurement.

12. The recipe of claim 9, further comprising at least one image and wherein the at least one image is selected from an ingredient image, a preparation step image, a completed recipe image, and combinations thereof.

13. The recipe of claim 9, further comprising at least one of a directional arrow indicating a preparation step of the recipe, a bullet point indicating a preparation step of the recipe, a demarcated ingredient section demarcated by color, a demarcated ingredient section demarcated by lines, and combinations thereof.

14. The recipe of claim 9, wherein the recipe is an electronic recipe configured to be displayed on an electronic device and wherein the electronic recipe further comprises at least one of a video clip, an audio clip, a next button, a stop button, a layering feature, a bolding feature, and combinations thereof.

15. The recipe of claim 9, further comprising at least one shopping list and wherein the at least one shopping list includes at least one ingredient image of an ingredient on the shopping list.

16. The recipe of claim 9, wherein the recipe is configured for users with at least one of a reading disorder, a language comprehension deficit, a phonological deficit, an orthographic processing deficit, a vocabulary weakness, and a generalized language learning disorder, and wherein the reading disorder comprises at least one of dyslexia and alexia.

17. A method for preparing a recipe comprising:
using a cookbook comprising a plurality of recipes, wherein each recipe includes:
at least one color-coded measurement, and
at least one demarcated ingredient section; and
preparing at least one ingredient according to a respective color-coded measurement.

18. The method of claim 17, wherein the cookbook is configured for users with at least one of a reading disorder, a language comprehension deficit, a phonological deficit, an orthographic processing deficit, a vocabulary weakness, and a generalized language learning disorder, and wherein the reading disorder comprises at least one of dyslexia and alexia.

19. The method of claim 17, wherein the cookbook is an electronic book configured to be displayed on an electronic device.

20. The method of claim 17, wherein preparing the at least one ingredient according to the respective color-coded measurement comprises using at least one color-coded identifier, wherein each identifier is associated with a color-coded measurement, and wherein the color-coded identifiers comprise at least one of colored stickers and colored zip ties.
